(19) United States
(12) Patent Application Publication
(10) Pub. No.: US 2025/0154064 A1
(43) Pub. Date: May 15, 2025

(54) PLASTIC BINDER SYSTEM

(71) Applicant: NILO Limited, Auckland (NZ)

(72) Inventors: Simon David Oakley, Auckland (NZ); Philip Kenneth Coveny, Auckland (NZ)

(21) Appl. No.: 18/720,199

(22) PCT Filed: Dec. 16, 2022
(86) PCT No.: PCT/NZ2022/050174

§ 371 Date: Jun. 14, 2024

Related U.S. Application Data
(60) Provisional application No. 63/290,588, filed on Dec. 16, 2021.

(51) Int. Cl. C04B 26/06; C04B 24/02; C04B 24/12; C04B 103/20; C04B 103/46; C04B 111/00; E01C 19/48

(52) U.S. Cl. CPC C04B 26/06; C04B 24/02; C04B 24/121; C04B 24/125; E01C 19/4866; C04B 2103/20; C04B 2103/46; C04B 2111/0075

(57) ABSTRACT

Described is a method of manufacturing a road comprising providing a binder comprising a plastic source, the plastic source comprising 15 to 40% by weight of a plastic that comprises a styrene unit, 20 to 45% by weight of a second plastic source being (1) a plastic having a styrene unit or (2) a styrene monomer, 5 to 35% by weight of an acrylate monomer, 5 to 30% by weight of a multifunctional monomer, and a promotor and cross linkercombining the binder with an aggregate to coat said aggregate, the aggregate having a moisture content of less than 6% by weight, provided a moisture control aid is also present, or less than 3% by weight moisture if a moisture control aid is not present, laying the mixture onto a roading base course at a thickness of between 50 to about 200 mm; and compacting the layer.

### FIELD OF THE INVENTION

The present invention relates to a plastic-derived binder system and its use to form roading.

### BACKGROUND TO THE INVENTION

Plastic waste has reached epidemic proportion with waste plastic now found practically on every area of the world, including in deep ocean trenches. According to National Geographic, half of all plastics ever manufactured have been made in the last 15 years with production having increased exponentially from 2.3 million tons in 1950 to 448 million tons by 2015. Production is expected to double by 2050. Approximately 8 million tons of plastic waste escapes into the oceans from coastal nations. Plastics can take up to 400 years to break down, but perhaps most troubling is the production of microplastics which are formed when plastics gradually break down.

While plastic recycling is well known, many countries have low recycling rates and even in those countries that do recycle, it is typically an uneconomic process and may require extensive processing, such as to remove organic matter from the plastic.

It is an object of the present invention to provide a process for processing plastic, to overcome any of the above-mentioned disadvantages, or to at least provide the public with a useful choice.

### SUMMARY OF THE INVENTION

In a first aspect there is described a plastic-containing binder, the binder comprising a plastic that comprises a styrene unit, a second plastic source being (1) a plastic having a styrene unit or (2) a styrene monomer, an acrylate monomer, a multifunctional monomer, and a promotor and cross linker.

In a further aspect there is described a plastic-containing binder, the binder comprising a plastic that comprises a styrene unit, a second plastic source being (1) a plastic having a styrene unit or (2) a styrene monomer, an acrylate monomer, a multifunctional monomer, a promotor, cross linker and a moisture control aid.

In a further aspect there is described a plastic-containing binder comprising providing a plastic source, the plastic source comprising
15 to 40% by weight of a plastic that comprises a styrene unit,
20 to 45% by weight of a second plastic source being (1) a plastic having a styrene unit or (2) a styrene monomer,
5 to 35% by weight of an acrylate monomer,
5 to 30% by weight of a multifunctional monomer, and a promotor and cross linker.

In a first aspect there is described a plastic-containing binder comprising providing a plastic source, the plastic source comprising
15 to 40% by weight of a plastic that comprises a styrene unit,
20 to 45% by weight of a second plastic source being (1) a plastic having a styrene unit or (2) a styrene monomer,
5 to 35% by weight of an acrylate monomer,
5 to 30% by weight of a multifunctional monomer,
a promotor and cross linker, and
a moisture control aid.

In a further aspect there is described a plastic-containing binder comprising providing a plastic source, the plastic source comprising
45 to 75% by weight of a plastic that comprises a styrene unit,
20 to 45% by weight of a second plastic source being (1) a plastic having a styrene unit or (2) a styrene monomer,
optionally 5 to 30% by weight of a multifunctional monomer, and
a promotor and cross linker.

In a further aspect there is described a method of manufacturing a road comprising
providing a binder as described,
combining the plastic-containing binder with a coarse aggregate that has a moisture content of less than 6% by weight and more preferably less than 3% by weight,
laying the mixture onto a roading base course, and
compacting the layer.

In a further aspect there is described a method of manufacturing a roading substrate comprising
providing a binder comprising,
   one or more plastic sources comprising a styrene unit,
   optionally an acrylate monomer,
   a multifunctional monomer,
   a promotor and cross linker,
   optionally a moisture control aid, and
combining the binder with an aggregate to coat said aggregate, the aggregate having a moisture content of less than 6% by weight and more preferably less than 3% by weight.

In a further aspect there is described a method of manufacturing a road comprising
providing a binder comprising,
   a plastic source comprising at least 30% by weight of total plastic of a plastic having a styrene unit,
   optionally an acrylate monomer,
   a multifunctional monomer,
   a promotor and cross linker
   optionally a moisture control aid, and
combining the binder with an aggregate to coat said aggregate, the aggregate having a moisture content of less than 6% by weight and more preferably less than 3% by weight,
laying the mixture onto a roading base course at a thickness of between 50 to about 200 mm, and
compacting the layer.

Any one or more of the following embodiments may relate to any of the aspects described herein or any combination thereof.

In one configuration the plastic source is depolymerised plastic.

In one configuration the binder comprises a moisture control aid.

In one configuration the multifunctional monomer is a triacrylate.

In one configuration the multifunctional monomer is selected from trimethylolpropane triacrylate or glycerol tripoxy triacrylate.

In one configuration the binder includes a retarder. The retarder may be selected from tertiary butyl catechol (TBC), tolu hydroquinone (HQ), acetoxime, or a combination thereof.

In one configuration the retarder may be present at about 100, 200, 300, 400, 500, 600, 700, 800, 900, 1000, 1500, 2000, 2500 or 3000 ppm.

In one configuration the cross-linker is multifunctional. Preferably it is trifunctional.

In one configuration the promotor is an amine based compound. In one configuration the promotor is an aniline derivative or analouge.

In one configuration the promotor is selected from N,N-dimethyl-p-toluidine (DMPT), N,N-dieethyl-p-toluidine (DEPT) or a combination thereof.

In one configuration the binder comprises a styrene monomer.

In one configuration the styrene monomer is polystyrene.

In one configuration the styrene copolymer is a polymer of styrene and acrylonitrile. In one embodiment the styrene copolymer is acrylonitrile butadiene styrene (ABS).

In one configuration the acrylic monomer is poly(methyl methacrylate).

In one embodiment the propylene-based thermoplastic polymer is polypropylene (PP).

In one embodiment the additive comprises 1, 2, 3, 4, 5, 6, 7, 8, 9, 10, 11, 12, 13, 14, 15, 16, 17, 18, 19 or 20% of the binder composition, and suitable ranges may be selected from between any of these values.

In one configuration the roading composition is absent any bitumen.

In one configuration the acrylate monomer is selected from a soft monomer.

In one configuration the acrylate monomer is selected from a hard monomer.

In one configuration the hard acrylate monomer is selected from methyl methacrylate, or a styrene monomer.

In one embodiment the soft acrylate monomer is selected from an ethyl hexyl acrylate (such as 2-ethyl hexyl acrylate).

In one configuration the binder comprises about 0.2, 0.25, 0.3, 0.35, 0.4, 0.45 or 0.5% by weight of a promotor, and suitable ranges may be selected from between any of these values.

In one configuration the binder comprises about 1, 2, 3, 4 or 5% cross-linker, and suitable ranges may be selected from between any of these values.

In one configuration the binder is combined with aggregate.

In one configuration the roading composition comprises the binder and aggregate. In one embodiment the roading composition comprises about 7, 8, 9, 10, 11 or 12% binder, and suitable ranges may be selected from between any of these values.

In one configuration the roading composition comprises the binder and aggregate at a ratio of binder to aggregate of 1:8 to about 1:14, and suitable ranges may be selected from between any of these values.

In one configuration a road is formed of a base layer formed of the plastic-containing roading binder composition in combination with an aggregate.

In one configuration the thickness of the road sub-base layer is 120, 130, 140, 150, 160, 170, 180, 190 or 200 mm, and suitable ranges may be selected from between any of these values.

In one embodiment the aggregate is dried to a water content of 0.1, 1, 1.5, 2, 2.5 or 3% moisture content by weight.

In one configuration the styrene is copolymerised with a soft monomer.

In one configuration the plastic source comprises at least 30% by weight of polystyrene based on the amount of total plastic and one plastic selected from a styrene copolymer, a copolymer of ethylene and vinyl acetate, acrylic polymer and nylon based polymers or co-polymers.

In one configuration the plastic source comprises at least 30% by weight of polystyrene based on the amount of total plastic and at least two different plastics selected from a styrene copolymer, a copolymer of ethylene and vinyl acetate, acrylic polymer and nylon based polymers or co-polymers.

In one configuration the plastic source comprises at least 30% by weight of polystyrene based on the amount of total plastic and at least three different plastics selected from a styrene copolymer, a copolymer of ethylene and vinyl acetate, acrylic polymer and nylon based polymers or co-polymers.

In one configuration the roading process includes a surface layer of plastic.

In one configuration the road surface layer of plastic is formed from a plastic slurry comprising particulate PET having a particle size of less than 8 mm in a carrier.

In one configuration the road surface layer of plastic is about 50 mm to about 100 mm in thickness.

In one configuration the source plastic comprises a plastic having a melting point above 105° C. to about 160° C.

In one configuration the high melt plastic is selected from polyethylene, PET, polypropylene, nylon, or a combination thereof.

In one configuration about 5% to about 15% by weight of high melt plastic is combined with the aggregate.

In one configuration the plastic binder is heated to a temperature of up to 30° C. when in the mixing tank.

In one configuration the plastic-aggregate mixture is heated to a temperature of up to 100° C. to 200° C.

In one configuration the heated plastic-aggregate mixture is combined with non-recyclable plastics, wherein the ratio of non-recyclable plastics to high-melt plastic is about 40:60.

In one configuration a colorant is added to the mixture.

As used herein, the phrase “comprises a styrene unit” means a plastic polymer that is a homopolymer of copolymer of styrene. That is, if a homopolymer then it solely contains styrene monomer units to form polystyrene. If a co-polymer then it contains at least one styrene monomer unit.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

The term “comprising” as used in this specification means “consisting at least in part of”. When interpreting statements in this specification which include that term, the features, prefaced by that term in each statement, all need to be present but other features can also be present. Related terms such as “comprise” and “comprised” are to be interpreted in the same manner.

### BRIEF DESCRIPTION OF THE DRAWINGS

The invention will now be described by way of example only and with reference to the drawings in which:

FIG. 1 is a graph showing the viscosity vs time at 5° C. for various amounts of BPO and DMPT.

FIG. 2 is a graph showing the viscosity vs time at 15° C. for various amounts of BPO and DMPT.

FIG. 3 is a graph showing the viscosity vs time at 25° C. for various amounts of BPO and DMPT.

FIG. 4 is a graph showing the viscosity vs time at 35° C. for various amounts of BPO and DMPT.

FIG. 5 is a graph showing a comparison of gel time for various cases at different testing temperature.

FIG. 6 is a graph showing a comparison of peak cure reaction temperature for various cases at different testing temperatures.

FIG. 7 is a graph showing the viscosity at various time points.

FIG. 8 is a graph showing the viscosity at various time points.

FIG. 9 is a graph showing the effect of retarder content on gel time.

### DETAILED DESCRIPTION OF THE INVENTION

Described is a method of preparing a binder and the use of that binder in the manufacture of a roading product.

The binder may comprise 15 to 40% by weight of a plastic that comprises a styrene unit, 20 to 45% by weight of a second plastic source being (1) a plastic having a styrene unit or (2) a styrene monomer, 5 to 35% by weight of an acrylate monomer, 5 to 30% by weight of a multifunctional monomer, and a promotor and cross linker.

The method may comprise providing a binder as described, combining the plastic-containing binder with a coarse aggregate that has a moisture content of less than 6% by weight and more preferably less than 3% by weight, laying the mixture onto a roading base course, and compacting the layer.

### 1. Plastic Source

The plastic may originate from a range of sources, such as virgin plastic or waste plastic.

Waste plastic provides a useful source of plastic for this process. In many countries waste plastic creates an environmental problem as society struggles to recycle or dispose of such plastic economically and safely. The sourced waste plastics may be for example the type of plastics derived from the waste recycling process. However, it will be appreciated various types of input plastic may be used depending on the desired output slurry.

Given the wide use of plastic in society, the waste plastic is typically sourced from every-day waste products such as plastic bottles (e.g. milk, carbonated drinks, water bottles, cleaning products), plastic containers (e.g. for industrial products such as oil, food items), and packaging (whether rigid or soft), although it will be appreciated that the product list of waste products is immensely broad.

Waste plastic is typically categorised. For example, plastics are often stamped with a chasing arrows triangle encompassing an identifying number as shown below.

| Category | Plastic | Description of plastic products |
|---|---|---|
| [symbol] | Polyethylene | Soft drink bottles, mineral juice, fruit |
| PETE | terephthalate | juice container, cooking oil |
| [symbol] | High density | Milk jugs, cleaning agents, laundry |
| HDPE | polyethylene | determents, bleaching agents, shampoo |
| | | bottles, washing and shower soaps |
| [symbol] | Polyvinyl | Trays for sweets, fruit, plastic packaging |
| PVC | chloride | (bubble foil) and food foils to wrap the |
| | | foodstuff. |
| [symbol] | Low-density | Crushed bottles, shopping bags, highly- |
| LDPE | polyethylene | resistant sacks and most of the wrappings |
| [symbol] | Polypropylene | Furniture, consumers luggage, toys, as |
| PP | | well as bumpers, lining and external |
| | | borders of cars, yoghurt and margarine |
| | | tubs |
| [symbol] | Polystyrene | Toys, hard packing, refrigerator trays, |
| PS | | cosmetic bags, costume jewellery, CD |
| | | cases, vending cups |
| [symbol] | Acrylic, | Large water bottles, some juice bottles |
| OTHER | polycarbonate, | |
| | polyactic fibres, | |
| | nylon, fibreglass | |

One source of plastic may be shredded plastic. Shredded plastic may be shredded to a particle size of less than about 20 mm.

The plastic may be selected from a plastic comprising a styrene unit, such as a styrene homopolymer or a styrene copolymer. Styrene is also known as ethenylbenzene, vinylbenzene, or phenylethene. The styrene based monomer can be polymerised (facilitated by the vinyl group) to form a homo- or copolymer. For example, the styrene based monomer may polymerise as a homopolymer to form polystyrene.

The styrene based monomer may form a co-polymer with one or more other compounds. For example,
with acrylonitrile in the presence of polybutadiene for example to form acrylonitrile butadiene styrene (ABS),
with butadiene for example to form styrene-butadiene or styrene-isoprene-styrene,
with ethylene and/or butylene for example to form styrene-ethylene-butylene-styrene (S-BE-S),
with divinylbenzene for example to form styrene-divinylbenzene (S-DVB),
with acrylonitrile to for example form styrene acrylonitrile (SAN),
with unsaturated polyesters that are typically used in resins and thermosetting compounds.

Styrene polymers are used to make latex, synthetic rubber, and polystyrene resins which are then used to make plastic packaging, disposable cups and containers, insulation, and other products. Styrene polymers are also used to make solid and film polystyrene (used in rigid foodservice containers), CD cases, appliance housings, envelope windows, polystyrene foam (used in food service products and building insulation), tub and shower enclosures, automobile body panels, wind turbine parts, boats, ABS plastic (used in refrigerator liners) small household appliances and luggage.

The styrene polymer may first be dissolved in an organic solvent such as chlorinated aliphatic hydrocarbons, organohalide solvent, aromatic hydrocarbon solvent, a mineral spirit, methyl ethyl ketone, ethyl acetate. Examples of suitable organic solvents include acetone, dichloroethane, tetrahydrofuran and toluene.

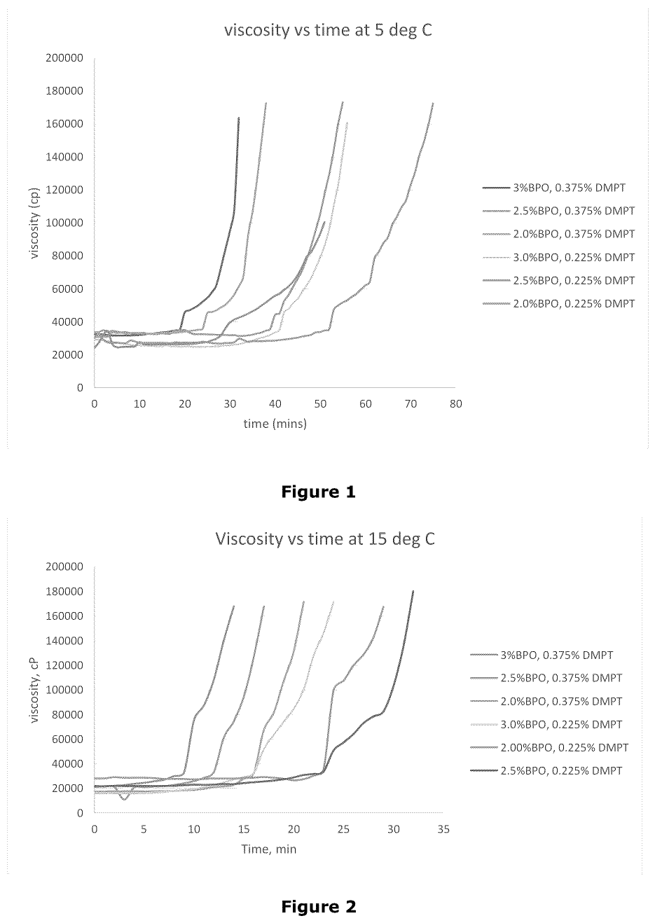

For example, the styrene polymer can be introduced into a tank that contains a suitable solvent. Once the styrene polymer is suitably dissolved, it can then be pumped to a mixing tank as shown in FIG. 1.

The plastic formed from a styrene based monomer is combined with another plastic selected from a plastic selected from a styrene copolymer, a copolymer of ethylene and vinyl acetate, acrylic polymer and nylon based polymers or co-polymers.

The styrene copolymer may be a polymer of styrene and acrylonitrile, such as acrylonitrile butadiene styrene (ABS). Given the binder is a combination of two or more different plastics, where one of the plastics is a polymer of styrene and acrylonitrile, the other plastic polymer is not a polymer of styrene and acrylonitrile.

In some configurations the plastic may be a virgin plastic. In such a case it may be necessary to add a cross linker to the virgin plastic as is done during the thermosetting process for plastic products. Common cross linkers lead to cross-linking based on peroxide cross-linking, radiation cross-linking and silane cross-linking.

In one embodiment the plastic source may be a depolymerised plastic. Depolymerised plastics are reverted to their monomer units. Various depolymerisation techniques have been described, for example, see Current Technologies in Depolymerization Process and the Road Ahead by Yu Miao Polymers 2021, 13 at page 449. The depolymerised plastic provides a feedstock for the process as described to form the binder. The monomer units formed by depolymerisation can be thermoformed and thermoset during the process of making the road, through the use of cross linkers and promotors of the cross linking process.

Binders for polymerisation may be formed from with monoethylenically unsaturated monomers, which may comprise a mixture of two or more monomer structural units in combination with a curing aid. Each unit may have a different homopolymer glass transition temperature (T_{g}), wherein a first monomer structural unit has a homopolymer T_{g} of greater than 80° C. and a second monomer having a homopolymer T_{g} of less than 80° C.

The second monomer may have a homopolymer T_{g} of less than 50° C.

The second monomer may have a homopolymer T_{g} of less than 25° C.

The glass transition temperature (T_{g})values for the homopolymers of the majority of monomers are known and are listed for example in Ullmann's Encyclopedia of Industrial Chemistry, volume A21, page 169, 5th edition, VCH Weinheim, 1992. T_{g} values for statistical copolymers can then be calculated using the Fox equation, 1/T_{g}=w1/T_{g},1+w2/T_{g},2+ . . . +wn/T_{g},n, where w1, w2, . . . , wn are the weight fractions of monomers 1, 2, . . . , n, and Tg,1, T_{g} 2, . . . , T_{g},n are the glass transition temperatures of their respective homopolymers (in Kelvin). Alternatively, the T_{g} values of the copolymers can be determined by differential scanning calorimetry (DSC) according to ISO 16805.

### 2. Acrylic Monomer (MMA)

The binder comprises an acrylate monomer. The acrylate monomer may be selected from poly(methyl methacrylate)(MMA).

The nylon based polymers or co-polymers are typically aliphatic or semi-aromatic polyamides.

The acrylate monomer is preferably a monomer that has a homopolymer T_{g} of greater than 80° C. which assists in providing hardness to the product that incorporates the binder. The first monomer may be based on ethylenically unsaturated monomer units. The ethylenically unsaturated monomer may comprise monoethylenically unsaturated monomer units and/or multiple unsaturated units, such as at least one vinyl group.

Monomer units comprising vinyl groups contain at least one C═C double bond which can be polymerized by known processes with further C═C double bonds or with further functional groups which can react with C═C double bonds, to give a polymer chain based at least partly on C—C recurring units. The polymer chain may comprise one or more side groups such as ionic, cationic or anionic functional groups. Such groups may be dissociable.

The monoethylenically unsaturated monomers may contain acid groups such as carboxylic acid groups, sulphonic acid or phosphonic acid. The monoethylenically unsaturated monomers may contain nitrogen groups like acrylamide, acrylonitrile and N-methylol acrylamide.

Ethylenically unsaturated carboxylic acid monomers may be selected from acrylic acid, methacrylic acid, ethacrylic acid, acyanoacrylic acid, β-methacrylic acid (crotonic acid), a-phenylacrylic acid, β-acryloxypropionic acid, sorbic acid, 2′-methylisocrotonic acid, cinnamic acid, β-stearylic acid, itaconic acid, citraconic acid, mesaconic acid, glutaconic acid, aconitic acid, maleic acid and fumaric acid.

Ethylenically unsaturated sulphonic acid monomers may be selected from allylsulphonic acid or aliphatic or aromatic vinylsulphonic acids or acrylic or methacrylic sulphonic acids. Aliphatic or aromatic vinylsulphonic acids may be selected from vinylsulphonic acid, 4-vinylbenzylsulphonic acid, vinyltoluenesulphonic acid and styrenesulphonic acid. Acryl- and methacrylsulphonic acids may be selected from sulphoethyl(meth)acrylic acid, sulphopropyl(methyl)acrylic acid, 2-hydroxy-3-methacryloxypropylsulphonic acid and (meth)acrylamidoalkylsulphonic acids, such as 2-acrylamido-2-methylpropanesulphonic acid.

Ethylenically unsaturated phosphonic acid monomers may be selected from vinylphosphonic acid, allylphosphonic acid, vinylbenzylphosphonic acid (meth)acrylamidoalkylphosphonic acids, acrylamidoalkyldiphosphonic acids, phosphonomethylated vinylamines and (meth)acrylphosphonic acid derivatives.

The monomer may be a derivatives of the abovementioned monomers containing acid groups. The monomer may be an ester derivatives, and in particular, ester derivatives that are obtainable by reaction of one of the abovementioned carboxylic acids with a linear or branched C₁-C₂₀ alcohol (preferably a linear or branched C₁-C₁₂ alcohol or a linear or branched C₁-C₈ alcohol or a linear or branched C₁-C₄ alcohol).

The monomer may comprise ester derivatives selected from methyl acrylate, ethyl acrylate, propyl acrylate, butyl acrylate, methyl methacrylate, ethyl methacrylate, propyl methacrylate or butyl methacrylate.

The monomer may comprise structural units of methyl methacrylate, butyl methacrylate, ethyl acrylate, butyl acrylate, or 2-ethylhexyl acrylate, or a combination thereof.

Any acrylic or methacrylic acid ester which, when polymerized, gives a homopolymer having a T_{g} value greater than 25° C., preferably greater than 50° C., can be used. Examples of suitable monomer esters include isobornyl acrylate, isobornyl methacrylate, methyl methacrylate, ethyl methacrylate, isopropyl methacrylate, isobutyl methacrylate, tert-butyl methacrylate, tert-butyl acrylate, n-propyl methacrylate, isobutyl methacrylate and cyclohexyl methacrylate.

The monomer may comprise from 20 to 80% by weight, more preferably from 25 to 75% by weight, most preferably from 30 to 70% by weight, of the monomer composition used to produce the copolymer dispersion described herein.

The second monomer may have a homopolymer T_{g} value of less than 80° C. and provides some degree of softening of the final product characteristics.

Any acrylic or methacrylic acid ester which, when polymerized, gives a homopolymer having a T_{g} value less than 25° C., preferably less than 0° C., can be used as the second monomer. Examples of suitable esters include methyl acrylate, ethyl acrylate, n-propyl acrylate, isopropyl acrylate, n-butyl methacrylate, n-butyl acrylate, isobutyl acrylate, 1-hexyl acrylate, 2-ethylhexyl acrylate, heptyl acrylate, n-octyl acrylate, 2-octyl acrylate, dodecyl methacrylate, dodecyl acrylate, tridecyl methacrylate, methacrylic ester 17.4, and mixtures thereof.

TABLE 1
Exemplified monomers and their glass transition temperature

| Monomer | Glass transition temp (° C.) |
|---|---|
| 2-EHA | −70 |
| Butyl Acrylate | −56 |
| Ethyl Acrylate | −22 |
| VEOVA 10 | −20 |
| 2-Hydroxy Ethyl Acrylate | −15 |
| Dibutyl Maleate | −10 |
| Hydroxy Propyl Acrylate | 6 |
| AAEM | 8 |
| Methyl Acrylate | 8 |
| DMAEMA | 18 |
| Butyl Methacrylate | 22 |
| Sipomer WAM | 30 |
| Vinyl Acetate | 30 |
| WAM IV | 30 |
| Allyl methacrylate | 52 |
| Hydroxy Ethyl Methacrylate | 55 |
| n-Methylolmethacrylamide | 59 |
| Isobutyl Methacrylate | 70 |
| GMA | 75 |
| Diacetone Acrylamide | 77 |
| Plex 6844-O | 90 |
| DMAPMA | 96 |
| Acrylonitrile | 97 |
| Itaconic Acid | 97 |
| Styrene | 100 |
| TMPTA | 100 |
| Methyl Methacrylate | 105 |
| Acrylic Acid | 106 |
| Acrylamide | 165 |
| Methacrylic Acid | 210 |
| Methacrylamide | 252 |
| n-Methylolacrylamide | 316 |

In one embodiment the acrylate monomer is an acrylate monomer selected from the acrylate monomers of Table 1.

The binder may also include a cross-linking moiety. The cross-linking moiety may comprise a bi- or tri-functional ester monomer such as trimethylolpropane triacrylate. The cross-linking agent assists to form the three-dimensional structure of the final product.

### 3. Cross Linker and Promotor

The binder may also include a cross-linker and a promotor. Promoters may increase the efficiency of cross linker initiated cure systems resulting in the rapid polymerisation.

The cross-linker may be a peroxide based cross-linker.

A cross linking agent is one that links one polymer chain to another. The links may be covalent or ionic bonds. Cross linking of thermoplastics is part of the curing process since when polymer chains are cross linked, the material becomes more rigid.

While cross linking can be initiated by heat, pressure, change in pH or irradiation, the cross linking agent as used herein refers to a chemical that results in a chemical reaction that forms cross links. That is not to exclude that cross linking may also occur due to the heat and pressure used in the current process.

In one configuration the cross linking agent may be a peroxide-based cross linker. In some configurations the peroxide can be selected from inorganic peroxides, diacyl peroxides, peroxyesters, peroxydicarbonates, dialkyl peroxides, ketone peroxides, peroxyketals, cyclic peroxides, peroxymonocarbonates, hydroperoxides, dicumyl peroxide, benzoyl peroxide, 2,5-Di(tert-butylperoxy)-2,5-dimethyl-3-hexyne, 3,3,5,7,7-pentamethyl 1,2,4-trioxepane, dilauryl peroxide, methyl ether ketone peroxide, t-amyl peroxyacetate, t-butyl hydroperoxide, t-amyl peroxybenzoate, D-t- amyl peroxide, 2,5-Dimethyl 2,5-Di(t-butylperoxy)hexane, t-butylperoxy isopropyl carbonate, succinic acid peroxide, cumene hydroperoxide, 2,4-pentanedione peroxide, t-butyl perbenzoate, diethyl ether peroxide, acetone peroxide, arachidonic acid 5-hydroperoxide, carbamide peroxide, tert-butyl hydroperoxide, t-butyl peroctoate, t-butyl cumyl peroxide, Di-sec-butyl-peroxydicarbonate, D-2- ethylhexylperoxydicarbonate, 1,1 -Di(t-butylperoxy)cyclohexane, 1,1 -Di(tert-butylperoxy)-3,3,5-trinnethylcyclohexane, 2,5-Dimethyl-2,5-di(tert-butylperoxy)hexane, 3,3,5,7,7-Pentamethyl-1,2,4-trioxepane, Butyl 4,4-di(tert-butylperoxy)valerate, Di(2,4-dichlorobenzoyl) peroxide, Di(4-methylbenzoyl) peroxide, Di(tert-butylperoxyisopropyl)benzene, tert-Butyl cumyl peroxide, tert-Butyl peroxy-3,5,5-trimethylhexanoate, tert-Butyl peroxybenzoate, tert-Butyl peroxy 2-ethylhexyl carbonate, and mixtures thereof.

In a preferred embodiment the cross linking agent is benzoyl peroxide.

The cross linker maybe present at about 1, 2, 3, or 4% by weight and suitable ranges may be selected from between any of these values, (for example, from about 1 to about 4, from about 1 to about 3, from about 1 to about 2, from about 2 to about 4, from about 2 to about 3% by weight of the binder).

The binder may also include a promoter. The promoter may increase the speed of polymerisation. Without wishing to be bound by theory, the promoter may increases the amount of free radicals by the cross linking agent, which increases the rate of polymerisation of the thermoplastic material to theromoset material. The promoter may be selected from N,N-dimethyl-p-toludine or N,N-diethyl-p-toludine.

The binder comprises a multifunctional monomer. The multifunctional monomer assists in polymerisation of the monomer units (such as the styrene monomer units) leading to the formation of crosslinked polymer materials.

The multifunctional monomer is preferably a triacrylate. For example, the multifunctional monomer may be selected from Trimethylolpropane triacrylate or glycerol tripoxy triacrylate or a combination thereof.

The binder as described may be used to manufacture a roading composition.

As discussed above, the binder may be formed from at least a mixture of plastics and solvent as shown in FIG. 2, or a combination of an acrylate monomer and a cross-linker as described above.

The binder may comprise a monomer as described in paragraphs [0083] to [0101].

The plastics source for use in the monomer binder may comprise a combination of plastics as described in paragraphs [0065] to [0082] above. The plastic source may comprise at least 30% by weight of the total plastic of a plastic that contains a styrene unit. In some configurations the plastic source comprises 30, 35, 40, 45, 50, 55 or 60% by weight of the total plastic of a plastic that originated from a styrene based monomer, and suitable ranges may be selected from between any of these values, (for example, about 30 to about 60, about 30 to about 50, about 30 to about 40, about 35 to about 60, about 35 to about 50, about 40 to about 60, about 40 to about 55, about 45 to about 60, about 50 to about 60% by weight of the total plastic of a plastic that originated from a styrene based monomer).

The relative amount of binder to aggregate may depend on the size of the aggregate. For example, the roading composition (comprising aggregate and binder) may comprise about 7, 8, 9, 10, 11, 12, 13, 14 or 15% binder, and suitable ranges may be selected from between any of these values (for example, about 7 to about 15, about 7 to about 12, about 7 to about 10, about 8 to about 15, about 8 to about 14, about 8 to about 11, about 9 to about 15, about 9 to about 13, about 9 to about 12, about 10 to about 15, about 10 to about 12 or about 13 to about 15% binder). That is the ratio of binder to aggregate may be about 1:8 to about 1:14, and suitable ranges may be selected from between any of these values.

The aggregate may have an average size of about 1 to 20 mm, and suitable ranges may be selected from between any of these values.

The binder is added to the aggregate and mixed such that the aggregate is coated by binder.

In some embodiments it is necessary to dry the aggregate to a moisture content of less than about 3% by weight moisture. For example, less than 3, 2, 1 or 0.5% by weight moisture, and suitable ranges may be selected from between any of these values (for example, from about 0.5 to about 3, from about 0.5 to about 2, from about 0.5 to about 1, from about 1 to about 3, from about 1 to about 2% by weight moisture).

The aggregate may be dried by exposing it to drying airflow. Heat may also be used to dry the aggregate.

In some embodiments the binder includes a moisture moisture control aid that controls the moisture present in the aggregate. This allows higher levels of moisture in the aggregate. For example, the moisture % by weight in the aggregate may be less than 6, 5, 4, 3 or 2% by weight, and suitable ranges may be selected from between any of these values.

A road may comprise multiple layers. For example, a paving layer as the lowermost layer, a sub-base and a top layer. In a typical road, the paving may be formed from concrete, with the subbase formed from a bitumen mix with or without aggregate, and then the top layer is a bitumen mix combined with aggregate (i.e. fines).

As the binder can replace bitumen in the road manufacturing process, the binder can be used in any one or more of these layers.

For example, in relation to the paving layer, this may be 200 to 300 mm in depth and may comprise a mixture of the binder combined with larger aggregate, such as aggregate having an average size of between 20 to about 30 mm.

In relation to the sub-base layer, this may comprise a 50 to 60 mm layer comprising a mixture of binder and aggregate having the average particle size of 1 to 5 mm as described above. In some embodiments, the aggregate used here is undissolved plastic that has been reduced in size to 1 to 5 mm particles. In one configuration the subbase layer may comprise only binder.

The aggregate, binder and optionally the plastic particle, may be mixed in situ, applied to the road and then rolled to form the road surface.

In one embodiment the binder-aggregate mixture (absent any undissolved plastic particles) may be mixed with the additive. In such an embodiment the roading mixture may be heated to 20, 25, 30, 35, 40, 45, or 50° C., and suitable ranges may be selected from between any of these values (for example, about 20 to about 50, about 20 to about 45, about 20 to about 40, about 20 to about 30, about 25 to about 50, about 25 to about 40, about 25 to about 35, about 25 to about 30, about 30 to about 50, about 30 to about 40, about 35 to about 50° C.).

In some embodiments the binder includes a retarder that slows the curing speed of the binder mixture. This may be required to allow time for the roading material to be spread and prepared prior to it curing. In some embodiments the retarder is selected from tertiary butyl catechol, tolu hydroquinone, acetoxime or a combination thereof preferably the retarder is in solution form.

The retarder may be present at about 100, 200, 300, 400, 500, 600, 700, 800, 900, 1000, 1500, 2000, 2500 or 3000 ppm, and suitable ranges may be selected from between any of these values.

In relation to the top layer this may be formed of the traditional bitumen-aggregate (fines) mixture, or the bitumen may be replaced by the binder. In some configuration the aggregate may be provided by plastic aggregate that is undissolved and that has been reduced in size to 1 to 5 mm particles.

Each layer is compressed after laying, such as by road rollers which process is well known in road manufacture. During the laying process, the binder-aggregate mixture may be held in a truck and dispensed on to the road. The truck may include a solvent recovery system that assists in recovering volatile solvent that escapes from the roading mixture during the laying process.

In one embodiment the binder may be applied via an in situ process and can be used with both aggregate for new road surface or reconstructing a previously laid road surface, mixing the old reground aggregate with new heated binder and relayed in situ.

### EXAMPLES

### Example 1—Monomer Based Roading

The purpose of this study was to investigate suitable monomer-based binders for roading application as shown in Table 3. The components included:
MMA (Methyl methacrylate)(hard monomer)
Styrene (hard monomer)
TMPTA (Trimethylolpropane triacrylate)(multifunctional monomer)
GTPTA (glycerol tripoxy triacrylate)(trifunctional monomer)
Polystyrene

In particular this example examines the use of DMPT (N,N-dimethyl-p-toludine)(used as promoter for crosslinking) and BPO (Benzoyl peroxide)(used as cross-linking agent/cross linker).

DMPT and BPO were added to the binder at 0.0375% and 3%, respectively. The tests were undertaken at 25° C. for gel time measurements.

Three cores were produced for each formulation. In all cases, using dried aggregate (dried to a moisture content of less than 3% by weight). The percentage of binder in the core was maintained at 10%. The cores were made using a gyratory compactor with the number of gyrations set to 100 and compaction force set to 6 KN.

All the cores were tested for Indirect Tensile Strength ITS and ITSM.

TABLE 2
The binder formulations tested

| | | | | | | Recycled |
|---|---|---|---|---|---|---|
| Tag | MMA | Styrene | TMPTA | GTPTA | Polystyrene | ABS |
| Base | 24 | 24 | 20 | | 32 | |
| A | 12 | 36 | 20 | | 32 | |
| B | 0 | 48 | 20 | | 32 | |
| C | 22 | 22 | 18 | | 38 | |
| D | 10 | 32 | 20 | | 38 | |
| E | | 58 | 10 | | 32 | |
| F | | 68 | 0 | | 32 | |
| G | 24 | 24 | | 20 | 32 | |
| H | | 63 | 5 | | 32 | |
| ABS-1 | 24 | 24 | 20 | | | 32 |

TABLE 3
Results showing ITS and ITSM

| | | Indirect Tensile | Resilient |
|---|---|---|---|
| Tag | Density, T/m³ | Strength, kPa | Modulus, MPa |
| Base | 2.296 | 1556 | 36191 |
| A | 2.300 | 1774 | 22269 |
| B | 2.268 | 1662 | 17693 |
| C | 2.13 | 1441 | 28932 |
| D | 2.266 | 1686 | 20676 |
| E | 2.278 | 2013 | 37675 |
| F | No Reaction | | |
| G | 2.210 | 2217 | 19092 |
| H | 2.187 | 3327 | 20760 |
| ABS-1 | 2.282 | 1766 | 28848 |

### Example 2—Moisture Content

The purpose of this study was to investigate suitable monomer-based binders for roading application based on different aggregate moisture content.

The base binder shown in Table 3 was used. DMPT and BPO were added to the binder at 0.0375% and 3%, respectively. The percentage of the binder in the core was maintained at 10%. Water was proportionally added to the dry aggregate and homogenized in a mixer.

Three roading cores were made at each moisture loading using the gyratory compactor with the number of gyrations set to 100 and compaction force set to 6 KN. Core curing was undertaken room temperature.

All the cores were tested for Indirect Tensile Strength (ITS) and ITSM.

TABLE 4
Results showing ITS and ITSM

| Tag | Moisture loading | Density, | Indirect Tensile | Resilient |
|---|---|---|---|---|
| No | in aggregate (%) | T/m³ | Strength, kPa | Modulus, MPa |
| M1 | 0 | 2.296 | 1556 | 36191 |
| M2 | 2 | 2.283 | 1549 | 8172 |
| M3 | 4 | 2.164 | 758 | 2024 |

### Example 3—Exploring the Impact of Plastics Addition to Replace a Portion of the Aggregate

The purpose of this study was to investigate suitable monomer-based binders for roading application based on the impact of plastics addition to replace a portion of the aggregate.

The base binder shown in Table 3 was used. DMPT and BPO were added to the binder at 0.0375% and 3%, respectively. The percentage of the binder in the core was maintained at 10%.

The aggregate was dried.

Three roading cores were made at each plastic loading using the gyratory compactor with the number of gyrations set to 100 and compaction force set to 6 KN. The plastic loading was at 10% of the total aggregate. The core was cured at room temperature. All of the cores were tested for ITS and ITSM.

TABLE 5
Results showing ITS and ITSM

| Tag | | Density, | Indirect Tensile | Resilient |
|---|---|---|---|---|
| No | Plastic | T/m³ | Strength, kPa | Modulus, MPa |
| P1 | Recycled PP | 1.341 | 171 | |
| P2 | Recycled HDPE | 1.469 | 16 | 36 |
| P3 | Recycled PET | 1.344 | 39 | |

### Example 4—Exploring GPTA as a Replacement of TMPTA in PTS4 Formulation with Dry Aggregate and with 4% Moist Aggregate

The purpose of this study was to investigate suitable monomer-based binders for roading application based on the impact of plastics addition to replace a portion of the aggregate.

The base binder shown in Table 3 was used. DMPT and BPO were added to the binder at 0.0375% and 3%, respectively. The percentage of the binder in the core was maintained at 10%.

The cores were produced using dried aggregate.

Three roading cores were made at each plastic loading using the gyratory compactor with the number of gyrations set to 100 and compaction force set to 6 KN. The plastic loading was at 10% of the total aggregate. The core was cured at room temperature. All of the cores were tested for ITS and ITSM.

TABLE 6
Results showing ITS and ITSM

| | Moisture in | Density, | Indirect Tensile | Resilient |
|---|---|---|---|---|
| Tag No | aggregate % | T/m³ | Strength, kPa | Modulus, MPa |
| GPTS4D | 0 | 2.210 | 2217 | 19092 |
| GPTS4W | 4 | 2.186 | 165 | 384 |

### Example 5—Exploring Gel Time and Cores with the Base Mixed with DEPT (Diethyl-p-Toluidine) as a Peroxide Activator

The purpose of this study was to investigate suitable monomer-based binders for roading application based on the use of DEPT as a peroxide activator.

The base binder shown in Table 3 was used. DEPT and BPO were added to the binder at 0.375% and 3%, respectively. The gel time measurements were undertaken at 25° C. The cores were produced using dried aggregate.

The cores were produced using dried aggregate.

The percentage of the binder in the core was maintained at 10%.

The cores were made using a gyratory compactor with the number of gyrations set to 100 and compaction force set to 6 KN. The cores were tested for Indirect Tensile Strength ITS and ITSM.

TABLE 7
Results showing ITS and ITSM

| | Density, | Indirect Tensile | Resilient |
|---|---|---|---|
| Tag No | T/m³ | Strength, kPa | Modulus, MPa |
| DEPT-1 | 2.278 | 2086 | 35129 |
| DEPT-2 | 2.284 | 2234 | 36132 |

### Example 6—Binder Formulations

The purpose of this study was to investigate various binder formulations as shown in Table 7. DEPT and BPO were added to the binder at 0.375% and 3%, respectively. The gel time measurements were undertaken at 25° C. The cores were produced using dried aggregate.

The cores were produced using dried aggregate.

The percentage of the binder in the core was maintained at 10%.

The cores were made using a gyratory compactor with the number of gyrations set to 100 and compaction force set to 6 KN. The cores were tested for Indirect Tensile Strength ITS and ITSM.

TABLE 8
The binder formulations tested

| Tag | MMA | Styrene | TMPTA GTPTA | Polystyrene |
|---|---|---|---|---|
| Base | 24 | 24 | 20 | 32 |
| A | 12 | 36 | 20 | 32 |
| B | 0 | 48 | 20 | 32 |
| C | 22 | 22 | 18 | 38 |
| D | 10 | 32 | 20 | 38 |
| E | | 58 | 10 | 32 |

TABLE 9
Results showing ITS and ITSM

| | | Indirect Tensile | Resilient |
|---|---|---|---|
| Tag | Density, T/m³ | Strength, kPa | Modulus, MPa |
| Base | | | |
| A | 2.158 | 2403 | 25229 |
| B | 2.188 | 2495 | 28083 |
| C | 2.120 | 2142 | 24602 |
| D | 2.105 | 2028 | 15559 |
| E | 2.112 | 2524 | 7442 |

### Example 7—Exploring Additional Plastic Addition to the Base Binder

The purpose of this study was to investigate various binder formulations as shown in Table 7. DEPT and BPO were added to the binder at 0.375% and 3%, respectively.

Produced three cores for each formulation. In all cases, using dried aggregate. [0167]% Binder in the core was maintained at 10%.

The cores were made using a gyratory compactor with the number of gyrations set to 100 and the compaction force set to 6 KN.

All the cores were tested for Indirect Tensile Strength ITS and ITSM.

| | | | | Indirect | Resilient |
|---|---|---|---|---|---|
| | | Additive | Density, | Tensile | Modulus, |
| Tag No | Additive | % | T/m³ | Strength, kPa | MPa |
| R-1 | Recycled | 5 | 2.164 | 2357 | 20073 |
| | Rubber | | | | |
| HDPE-1 | Recycled | 5 | 2.106 | 1969 | 24995 |
| | HDPE | | | | |

### Example 8—Exploring the Effect of Temperature on Gel Time and Cure Reaction Temperature of the Base Binder

Isothermal gel-time testing was conducted with reduced levels of BPO and DMPT according to the test matrix detailed below

| | |
|---|---|
| BPO addition (%) | DMPT addition (%) |

| | | |
|---|---|---|
| 3 | 0.375 | 0.225 |
| 2.5 | 0.375 | 0.225 |
| 2 | 0.375 | 0.225 |

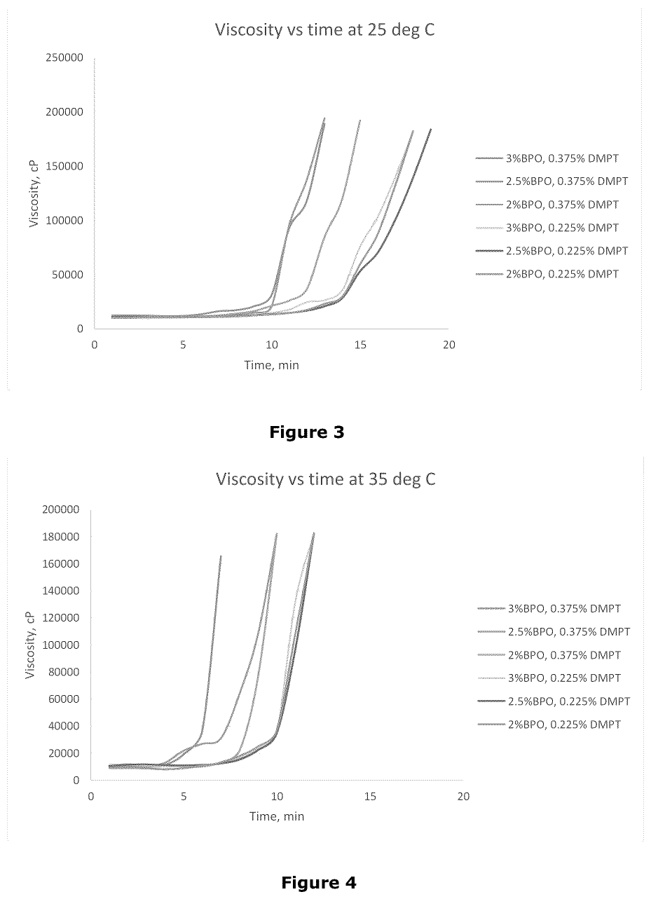

The tests were conducted at 5, 15, 25 and 35° C., and the results are shown in FIGS. 1 to 4.

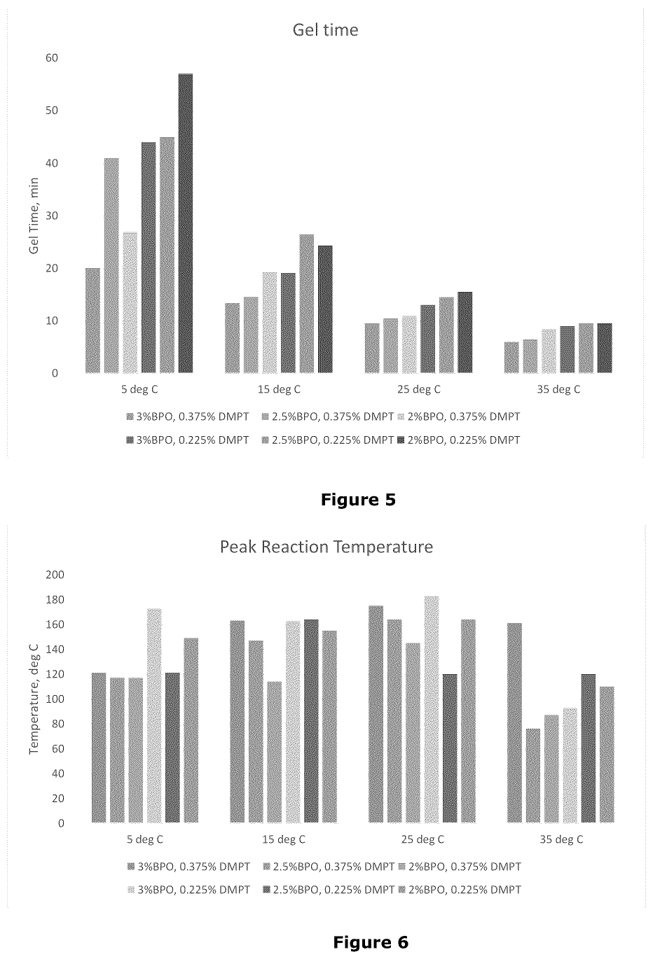

The comparison of gel time for various cases at different testing temperatures is provided in FIG. 5.

A comparison of peak cure reaction temperature for various cases at different testing temperatures is provided in FIG. 6.

### Example 9—Exploring the Effect of the Retarder on Gel Time and Cure Reaction Temperature of PTS4 Binder

The purpose of this study was to investigate various binder formulations as shown in Table 7. DEPT and BPO were added to the binder at 0.375% and 3%, respectively.

Gel time testing was conducted at 25° C.

Retarders used were tertiary butyl catechol (TBC), tolu hydroquinone (HQ) and acetoxime,

A 24.8% solution of the individual retarder was prepared in Iso Propyl alcohol (IPA) and used in the trials.

The trials were conducted according to the test matrix given below.

| Tertiary Butyl Catechol | | | | Tolu HydroQuinone | | | | Acetoxime solution, | | |
|---|---|---|---|---|---|---|---|---|---|---|
| solution, ppm | | | | (HQ) solution, ppm | | | | ppm | | |
| 200 | 500 | 800 | 2000 | 200 | 500 | 800 | 2000 | 200 | 500 | 800 |

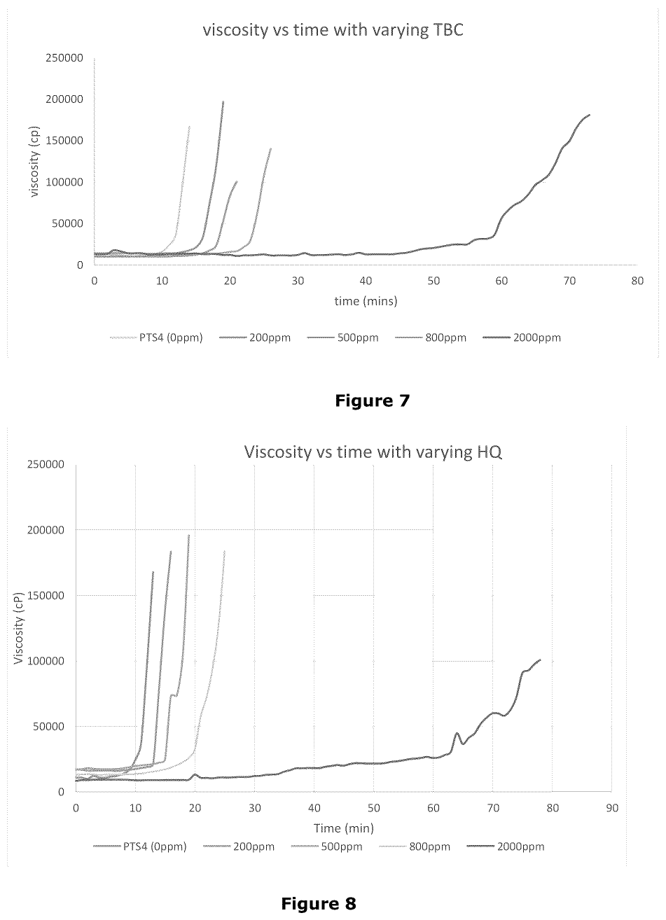

The results are shown in FIGS. 7 and 8.

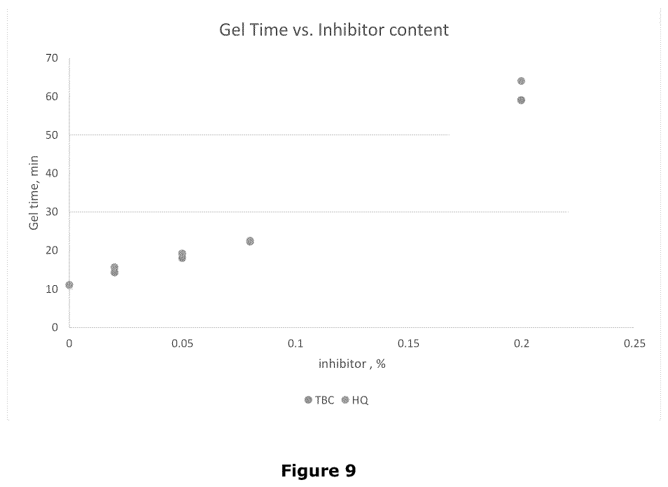

The effect of retarder content on the gel time are shown in FIG. 9.

We claim:

1. A plastic-containing binder comprising
a plastic source, the plastic source comprising 15 to 40% by weight of a plastic that comprises a styrene unit,
20 to 45% by weight of a second plastic source being (1) a plastic having a styrene unit or (2) a styrene monomer,
5 to 35% by weight of an acrylate monomer,
5 to 30% by weight of a multifunctional monomer, and
a promotor and cross linker.

2. A plastic-containing binder comprising
a plastic source, the plastic source comprising 15 to 40% by weight of a plastic that comprises a styrene unit,
20 to 45% by weight of a second plastic source being (1) a plastic having a styrene unit or (2) a styrene monomer,
5 to 35% by weight of an acrylate monomer,
5 to 30% by weight of a multifunctional monomer,
a promotor and cross linker, and
a moisture control aid.

3. A binder of claim 1 or 2 wherein the plastic source comprises depolymerised plastic.

4. A binder of claims 1 or 3 wherein the binder further comprises a moisture control aid.

5. A binder of any one of claims 1 to 4 wherein the multifunctional monomer is a triacrylate.

6. A binder of claim 5 wherein the triacrylate is selected from trimethylolpropane triacrylate or glycerol tripoxy triacrylate or a combination thereof.

7. A binder of any one of claims 1 to 6 further comprising a retarder.

8. A binder of claim 7 wherein the retarder is selected from tertiary butyl catechol (TBC), tolu hydroquinone (HQ), acetoxime, or a combination thereof.

9. A binder of claim 7 or 8 wherein the retarder is present in the binder at about 100 to 3000 ppm.

10. A binder of any one of claims 1 to 9 wherein the cross-linker is at least trifunctional.

11. A binder of any one of claims 1 to 10 wherein the promotor is selected from N,N-dimethyl-p-toluidine (DMPT), N,N-dieethyl-p-toluidine (DEPT) or a combination thereof.

12. A binder of any one of claims 1 to 11 wherein the multifunctional monomer is selected from Trimethylolpropane triacrylate or glycerol tripoxy triacrylate, or a combination thereof.

13. A binder of any one of claims 1 to 12 in combination with aggregate.

14. A binder of claim 13 with a moisture content of less than 6% by weight, provided a moisture control aid is also present.

15. A binder of claim 13 with a moisture content of less than 3% by weight moisture.

16. A binder of any one of claims 14 to 16 absent any bitumen.

17. A method of manufacturing a road comprising
providing a binder of any one of claims 1 to 12
combining the binder with an aggregate to coat said aggregate, the aggregate having a moisture content of less than 6% by weight, provided a moisture control aid is also present, or less than 3% by weight moisture if a moisture control aid is not present,
laying the mixture onto a roading base course at a thickness of between 50 to about 200 mm; and
compacting the layer.

18. A method of claim 17 wherein the binder comprises a styrene monomer being polystyrene.

19. A method of claim 17 or 18 wherein the acrylate monomer is selected from a soft monomer.

20. A method of of claim 17 or 18 wherein the acrylate monomer is selected from a hard monomer.

21. A method of any one of claims 17 to 20 comprising a peroxide cross-linker selected from benzoyl peroxide.

22. A method of any one of claims 17 to 21 wherein the binder is mixed with an aggregate, wherein the binder comprises about 8 to about 16% by weight of the total mixture.
